(19) United States
(12) Patent Application Publication
(10) Pub. No.: US 2014/0129654 A1
(43) Pub. Date: May 8, 2014

(54) Media exchange network supporting local and remote personalized media overlay

(71) Applicant: BROADCOM CORPORATION, Irvine, CA (US)

(72) Inventors: Jeyhan Karaoguz, Irvine, CA (US); James D. Bennett, Hroznetin (CZ)

(73) Assignee: BROADCOM CORPORATION, Irvine, CA (US)

(21) Appl. No.: 14/152,749

(22) Filed: Jan. 10, 2014

Related U.S. Application Data
(63) Continuation of application No. 10/675,448, filed on Sep. 30, 2003.
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/447,131, filed on Feb. 12, 2003.

(51) Int. Cl. H04L 29/08

(52) U.S. Cl. CPC H04L 67/10
USPC 709/206; 709/204

(57) ABSTRACT

Certain aspects of the invention for displaying alerts in a communication network may comprise receiving an alert from a first device coupled to the communication network. A message corresponding to the received alert may be generated within a home and displayed on a television screen within the home. The generated message may be displayed along with a media broadcast on the television screen and an acknowledgment of the displayed message may be received via a user selection. The acknowledgement may be received from a remote control that controls various functions of the television screen. Displaying of the generated message may be terminated upon receiving the acknowledgement or the generated message may be displayed for a predetermined or specified period of time. The alert, which may be received via a wireless and/or a wired connection, may indicate a status of the first and/or a second device.

### CROSS-REFERENCE TO RELATED APPLICATIONS

The present U.S. Utility patent application claims priority under 35 U.S.C. §120, as a continuation of U.S. Utility patent application Ser. No. 10/675,448, filed on Sep. 30, 2003, which is incorporated herein by reference in its entirety for all purposes.

The Ser. No. 10/675,448 application claims priority under 35 U.S.C. §119(e) to U.S. Provisional Patent Applications No. 60/457,179, filed on Mar. 25, 2003; No. 60/447,131, filed on Feb. 12, 2003; No. 60/443,894 filed on Jan. 30, 2003; and No. 60/432,472, filed on Dec. 11, 2002. The complete subject matter of all four Provisional Applications are incorporated herein by reference in their entirety for all purposes.

In addition, Applicants incorporate herein by reference, in their entirety, the complete subject matter of U.S. Utility patent application Ser. No. 10/660,267, filed on Sep. 11, 2003; and U.S. Utility patent application Ser. No. 10/657,390, filed on Sep. 8, 2003.

### FIELD OF THE INVENTION

The present invention relates to providing personalized media overlays to a user. In particular, certain embodiments of the present invention relate to providing local and remote personalized media overlays to a user of a communication network for communicating media or media exchange network, indicating the status of media peripherals and home appliances, and making the user aware of newly available media on the media exchange network.

### BACKGROUND OF THE INVENTION

Today, home appliances often have timers, buzzers, light emitting diodes (LEDs) and/or beepers that are utilized to indicate a status of the home appliance. For example, an oven may have a timer that beeps whenever a stated time has expired, thereby indicating, for example, that baking of a cake in the oven should be complete. In the case of a washing machine, a buzzer may emit a buzz, which may indicate that a particular washing cycle has been entered or that a current laundry load has completed washing. In another example, a light such as a red LED may remain lit while a dish washer is still operating. In this regard, upon completion of the rinse and/or dry cycle, the red LED may be unlit and a green LED may be lit.

A media peripheral, such as a digital camcorder, may indicate that its battery or power pack charge is low by flashing a message while a user looks through the view finder or a video display, and/or by providing an analog or digital battery meter. In the case of a digital camera, a flashing red LED or a plurality of bars on an LCD may indicate that a memory of a digital camera is full. In some instances, graduations on a scale such as on a meter may be utilized to indicate an ongoing condition of a device. In effect, the graduations on the screen may function as an electronic meter. For example, an electronic meter comprising a sliding bar may indicate the amount of available memory in a media peripheral.

A user of a personal computer (PC) may become aware of new emails by opening up an email application on the personal computer or by the personal computer displaying an icon or pop-up message indicating that a new email has arrived. To become aware or acquire knowledge of newly available media that may be of interest to a user, the user may have to search the Internet, watch a television for long period of time, listen to the radio, and/or scan newspapers and magazines for advertisements. A user of a personal computer may also receive email advertisements from various vendors and/or advertisers which may alert a user of the presence of newly available media. In certain instance, alerts may be provided based on a history of prior purchases made by the user.

Further limitations and disadvantages of conventional and traditional approaches will become apparent to one of skill in the art, through comparison of such systems with the present invention as set forth in the remainder of the present application with reference to the drawings.

### BRIEF DESCRIPTION OF SEVERAL VIEWS OF THE DRAWINGS

FIG. 1A is a schematic block diagram illustrating an exemplary communication network that may be utilized in connection with supporting remote personalized overlay, in accordance with an embodiment of the present invention.

FIG. 1B is a diagram illustrating an embodiment of a media exchange network supporting local and remote personalized media overlay, in accordance with various aspects of the present invention.

FIG. 1C is a diagram illustrating an embodiment of a personalized media overlay window that may be displayed on a television screen of the media processing system in the media exchange network of FIG. 1B, in accordance with various aspects of the present invention.

FIG. 2A is a flowchart illustrating exemplary steps for a method that may be utilized to provide a local personalized media overlay in the media exchange network of FIG. 1A, in accordance with various aspects of the present invention.

FIG. 2B is a flowchart illustrating exemplary steps for a method that may be utilized to provide a remote personalized media overlay in the media exchange network of FIG. 1A, in accordance with various aspects of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the invention may be found in a method and system for displaying alerts in a communication network. The method for displaying alerts in a communication network may comprise receiving an alert from a first device coupled to the communication network. A message corresponding to the received alert may be generated within a home and displayed on a television screen within the home. The generated message may be displayed along with a media broadcast on the television screen within the home and an acknowledgment of the displayed message may be received via a user selection. The acknowledgement may be received from a remote control that controls various functions for the television screen. The displaying of the generated message may be terminated upon receiving the acknowledgement or the generated message may be displayed for a predetermined or specified period of time.

In accordance with an aspect of the invention, the alert, which may be received via a wireless and/or a wired connection, may indicate a status of the first device and/or a second device. The first device may be located outside the home, while the second device may be located outside of or inside the home, for example. The generated message may be displayed in a pop-up window, a picture-in-picture (PIP) window and a banner on the television screen.

Another embodiment of the invention may provide a machine-readable storage, having stored thereon, a computer program having at least one code section for displaying alerts in a communication network. The at least one code section may be executable by a machine, thereby causing the machine to perform the steps as described above for displaying alerts in a communication network.

Certain embodiments of the system for displaying alerts in a communication network may comprise at least one processor that receives an alert from a first device coupled to the communication network. The processor may generate a message corresponding to the received alert within a home and display the generated message on a television screen within the home. In an aspect of the invention, the processor may cause the generated message to be displayed along with a media broadcast on the television screen within the home. An acknowledgment of the displayed message may be received by the processor via a user selection. The processor may also receive an acknowledgement from a remote control that controls various functions of the television screen. The processor may also be adapted to terminate displaying of the generated message after receiving the acknowledgement or after the generated message has been displayed for a predetermined or specified period of time.

In accordance with an aspect of the invention, the alert, which may be received by the processor via a wireless and/or a wired connection, may be utilized to indicate a status of the first device and/or a second device. The first device may be located outside the home, while the second device may be located either outside or inside the home, for example. The processor may cause the generated message to be displayed in a pop-up window, a picture-in-picture (PIP) window or a banner on the television screen. The processor may be a media processing system processor, a media management system processor, a computer processor, a media exchange software processor and/or a media peripheral processor.

These and other advantages, aspects and novel features of the present invention, as well as details of an illustrated embodiment thereof, will be more fully understood from the following description and the drawings.

Certain embodiments of the invention may be found in a method and system for displaying alerts in a communication network. Aspects of the method for displaying alerts in a communication network may comprise receiving an alert from a first device coupled to the communication network. A message corresponding to the received alert may be generated within a home and displayed on a television screen within the home. The alert may be received by the processor via a wireless and/or a wired connection, and may be utilized to indicate a status of the first communication device and/or a second communication device.

In one aspect of the invention, the generated message may be displayed along with a media broadcast on the television screen within the home. An acknowledgment of the displayed message may be received via a user selection. The acknowledgement may be received from a remote control that may be utilized to control various functions for the television screen. The displaying of the generated message may be terminated upon receiving the acknowledgement or the generated message may be displayed for a predetermined or specified period of time.

In accordance with an aspect of the invention, the alert, which may be received via a wireless and/or a wired connection, may indicate a status of the first device and/or a second device. The first device may be located outside the home, while the second device may be located within or external to the home, for example. The generated message may be displayed in a pop-up window, a picture-in-picture (PIP) window and a banner on the television screen.

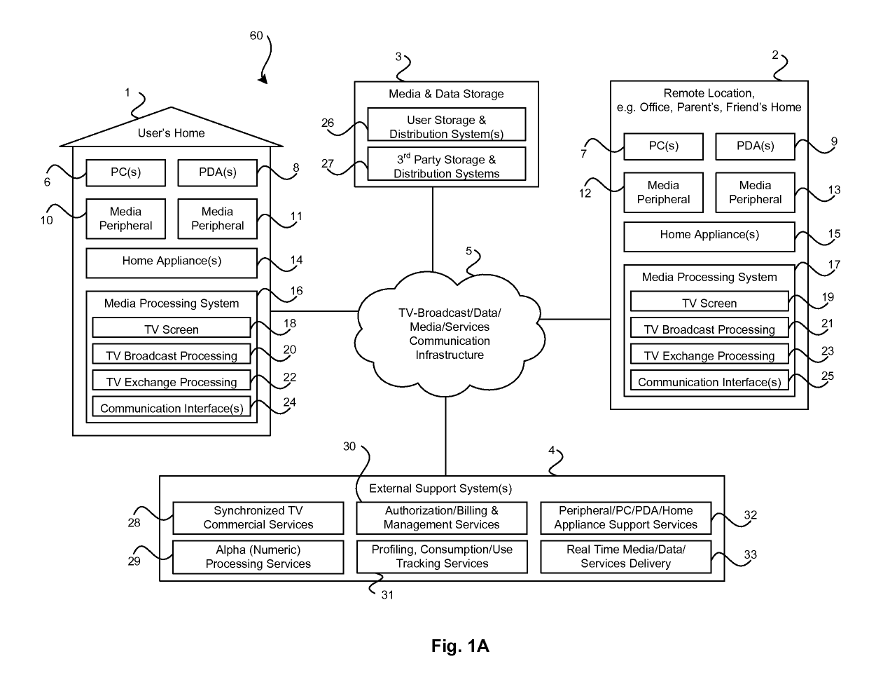

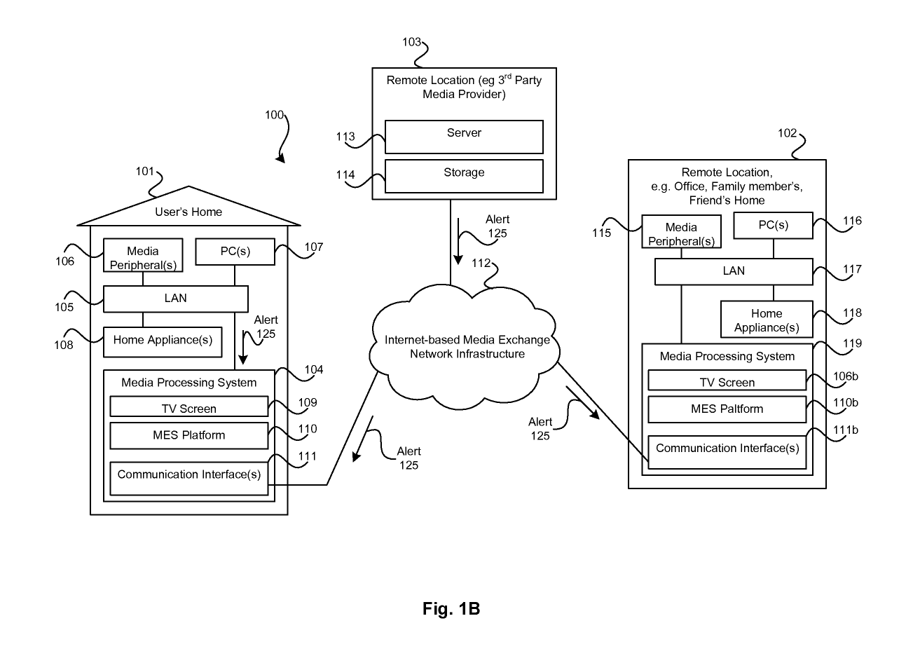

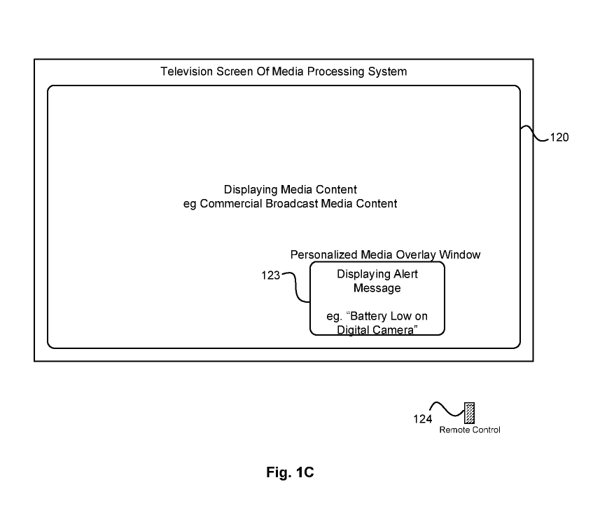

FIG. 1A is a schematic block diagram illustrating an exemplary communication network that may be utilized in connection with supporting remote personalized overlay in accordance with an embodiment of the present invention. Referring to FIG. 1A, the media exchange network 60 may include a first location such as a user's home 1, a remote location 2, media and data storage 3, external support systems 4, and a communication infrastructure 5. The communication infrastructure 5 may provide a common communication transport that may link the user's home 1, the remote location 2, the media and data storage 3 and the external support systems 4. The remote location 2 may include, for example, an office, a parent's home, and/or a friend's home.

The first location or user's home 1 may include PC 6, PDA 8, media peripherals 10, 11, home appliance 14, and a media processing system (MPS) 16. The remote location 2 may include PC 7, PDA 9, media peripherals 12, 13, home appliance 15 and a media processing system (MPS) 16 and 17, respectively. Media peripherals, as used herein, may include media capture devices, media player devices and any combination thereof. The media capture devices may include, for example, digital cameras and digital camcorders. The media player devices may include, for example, WMA and MP3 players. Although the media peripherals may be integrated with a personal computer, the invention is not limited in this regard. Accordingly, media peripherals may be external to the personal computer and may be standalone or portable devices. A personal computer (PC) comprising media exchange software (MES) running on or being executed by the personal computer, may also be referred to as a media processing system.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

A fully integrated media processing system having a television screen may be designed from the ground up having full media processing capability. The media processing systems 16, 17 may be fully integrated media processing systems. Media processing system 16 may include a television screen 18, a television broadcast processing platform 20, a television exchange processing platform 22 and communication interface(s) 24. Media processing system 17 may include a television screen 19, a television broadcast processing platform 21, a television exchange processing platform 23 and communication interface(s) 25. Alternatively, a set-top-box may be software enhanced and interfaced with a television to form a media processing system.

The communication infrastructure 5 may include cable infrastructure, xDSL infrastructure, Internet infrastructure, intranet infrastructure or other similar access and/or transport infrastructure that may facilitate the exchange of media and/or data between, for example, the user's home 1 and the remote location 2 and/or the media and data storage 3. The media and data storage 3 may include user storage and distribution systems 26 and also third party storage and distribution systems 27.

The external support systems 4 may include synchronized or unsynchronized commercial services 28; alpha/numeric processing services 29; authorization/billing and management services 30; profiling, consumption/use tracking services 31; peripheral/PC/PDA/home appliance support services 32; and real time media/data/services delivery 33.

In general, a television screen may be utilized to coordinate the exchange of media, data, and/or services between devices that are part of a media exchange network. For example, television screen 18 may be utilized to coordinate the exchange of media, data, and/or services between devices that are part of the media exchange network 60. The television screen may be utilized to execute setup, initiate and control functions for the exchange of media in conjunction with a media processing system such as MPS 16. The television exchange processing platform 22 may provide a television guide look-and-feel to a user. In accordance with an aspect of the invention, the television guide look-and-feel may be displayed to the user as a television channel guide user interface.

U.S. patent application Ser. No. 10/675,382 filed Sep. 30, 2003 and U.S. patent application Ser. No. 10/675,467 filed Sep. 30, 2003 provides exemplary media view or guide, device view or guide, and channel view or guide, and are hereby incorporated herein by reference in their entirety.

The television (TV) broadcast processing platform 20, may include suitable circuitry that is utilized for broadcast channel tuning, amplification and/or decoding of media for consumption. However, in one embodiment, the circuitry utilized for broadcast channel tuning, amplification and/or decoding is not utilized for the functions of television exchange processing, except that image generation circuitry may be utilized to drive the television screen for a television channel guide user interface.

In an illustrative embodiment of the invention, a user at the first location or the user's home 1 may have a desire to transfer pictures from media peripheral 10 to PDA 9 using the television screen 18 and a remote control to command the exchange. The media peripheral 10 may be a digital camera and the television screen 18 may have a television guide look-and-feel. During the media exchange process, the pictures are not actually being consumed or viewed by the user on the television screen. Accordingly, the core or heart of the television broadcast processing platform 20, which includes channel tuning, amplification and/or decoding, is not being utilized. The television exchange processing platform 22 in the media processing system 16, however, is being utilized to coordinate, command, and accomplish the exchange. The communication interfaces 24 provide the interface between the television screen 18 and the television exchange processing platform 22 in the media processing system 16.

In another illustrative embodiment of the invention, a user at the first location or user's home 1 may have a desire to transfer digital pictures from their digital camera 10 to the remote media processing system (MPS) 17 situated at the remote location 2. In this regard, the user may issue a command that may cause the pictures to be transferred from the digital camera 10 to the remote media processing system 17 via the communication infrastructure 5. In this case, the media exchange may also be coordinated by the television exchange processing platform 22 in the media processing system 16. In general, the media exchange network 60 may permit or facilitate the exchange of media from a first memory or storage location to a second memory or storage location within the network 60, using a television channel guide user interface. The television channel guide user interface may be displayed on a television screen 18.

The exchange of media may take place between various system components or entities. For example, the exchange of media may take place between two or more media peripherals 10, 11, 12, 13 such as digital cameras and PDAs, cell phones and digital cameras. The various media peripherals may be locally or remotely situated with respect to a user and/or with respect with each other. Exchange of media may take place between one or more media peripherals 10, 11, 12, 13 and one or more media storage devices 3, 6, 7. For example, data may be transferred from a digital camera to a PC using a television channel guide user interface on the TV screen 18. In another example, data may be moved from a personal computer to a hard drive of a personal video recorder (PVR) situated in the user storage and distribution system 25 or to a storage portion of the media peripheral system 16. Again, the media peripherals and/or media storage devices may be locally or remotely located with respect to a user and/or with respect to each other.

The exchange of media may also take place between a television and one or more media peripherals 10, 11, 12, 13 or media storage devices 3, 6, 7. The television, media peripherals, and/or media storage devices may be situated locally and/or remotely with respect to a user and/or with each other. In accordance with an aspect of the invention, the exchange of media may be accomplished through the use of various media peripheral control features and commands. For example, a user may utilize various specified commands to program, exchange and/or deliver audio, video, and/or image media channels. Even though the delivery may occur in real time, the invention is not so limited. Accordingly, various media peripheral control features and commands may be utilized to schedule the transfer or exchange of media.

Control of the media exchange may be scheduled, arranged or organized by a user via the television screen 18 using television exchange processing platform 22. In this regard, the television exchange processing platform 22 may control the exchange of media between two or more media peripherals. Notwithstanding, the television exchange processing platform 22 may also control the exchange of media within a single media peripheral. For example, media may be transferred from a first location such as a short term memory within a media peripheral to a second location such as an archive within the media peripheral.

Control commands for setup and delivery may be managed or handled by the television exchange processing platform 22. Alternatively, control of media exchange may be arranged by a user via a television screen 19 using a television exchange processing platform 23. The television exchange processing platform 23 may be utilized to exchange media between two or more media peripherals. However, the control commands that may actually be utilized to accomplish the exchange may be performed directly between the two media peripherals through a peer-to-peer interface, for example.

The management of memory, such as evaluating how much memory storage space is currently available or will be available in a media peripheral may be controlled using certain media peripheral commands in accordance with various embodiments of the present invention. Similarly, the moving and migrating of media files in an automatic manner may also be controlled by certain media peripheral commands. For example, a user at the first location or user's home 1 may issue a command that would result in or cause digital pictures or copies of digital pictures situated in their digital camera 10 to be stored within a memory of the local media processing system 16. In another example, the user at the first location may also issue a command the may cause or result in the pictures or copies of the pictures situated in their digital camera 10 to be archived in the user storage and distribution system 26.

A user may also initiate certain media peripheral commands that may automatically cause media to be routed to other users as soon as the digital media is created. In this regard, a user may setup or initialize a media peripheral with a level of authorization that may cause media to be automatically routed or migrated. For example, as soon as a user takes a picture with a digital camera 10 at the first location or user's home 1, the digital picture file that is generated may be automatically routed or forwarded to certain friends and family members at, for example, the second or remote location 2 via the communication infrastructure 5. The exchange may be automatically carried out by television exchange processing platform 22 in media processing system 16 without any user intervention or interaction, except for the taking of the picture.

Various third (3^{rd}) party services may also be provided by the media exchange network 60. For example, synchronized television commercial services 28 may also be provided. Television channel requests may be synchronized to commercials provided by a third (3^{rd}) party such as the external support system 4. In this regard, a particular television commercial, for example, may have an associated code that a user at the first location or user's home 1 may enter using their remote control and television channel guide user interface. The associated television commercial code may be displayed along with the television commercial on the television screen 18. The user may respond to the television commercial by entering the code within the television guide user interface displayed on the television screen 18. The code may be processed by the television exchange processing platform 22 in the media processing system 16 and transmitted via the communication infrastructure 5 to the external support system 4. Accordingly, the third (3^{rd}) party may subsequently transfer or push detailed advertisement media, for example, to the media processing system 16 at the first location or user's home 1 via the communication infrastructure 5.

Similarly, alpha-numeric processing services 29 may be provided. For example, third (3^{rd}) party providers may advertise alpha-numeric sequences over the radio or in magazines. A user having knowledge of the alpha-numeric sequences may enter the sequences using a remote control and television channel guide user interface, in order to request that the advertised media be pushed to the user via the media exchange network 60. The request may be communicated, for example, from media processing system 17 at the second or remote location 2 to the communication infrastructure 5, and then to external support system 4.

In another aspect of the invention, certain media peripheral commands may be initiated by a user for testing a media peripheral. In this regard, a user may initiate a test of a media peripheral using a remote control, or a third (3^{rd}) party may initiate a test of the media peripheral remotely. For example, a battery condition level of a media peripheral which may indicate whether the battery needs to be recharged or not, may be remotely checked. Other key features such as configuration information may also be examined or checked as well. Checking certain features of a media peripheral, such as a battery charge level, may also be configured or scheduled to be performed periodically and automatically without user initiation or intervention. Accordingly, a user may be alerted, via a display screen such as the television screen, when a problem is identified and/or whether some action needs to be taken. In cases where user intervention may be required, real time alerts may be delivered to the user. In the case of non-critical or informational alerts, these may be delivered at a later time such as during off peak hours.

For example, the third (3^{rd}) party peripheral/PC/PDA/home appliance support services 32 in external support system 4 may check a battery charge level of the media peripheral 13, which may be situated at the second or remote location 2 once per day. The execution and communication of the service may be accomplished from external support system 4 to communication infrastructure 5, on to media processing system 17, and finally to media peripheral 13. In instances where the battery charge level is determined to be low, external support system 4 may deliver, in a similar manner, a pop-up warning or banner that may appear on the screen 19 of media processing 17. This pop-up or banner may operate as an indication to the user, alerting the user to re-charge or change the battery for the media peripheral 13.

An embodiment of the invention may also include providing remote media peripheral updates. In this regard, a user may initiate various media peripheral commands that may result in the performance of software and/or firmware upgrades of media peripherals. For example, a user may utilize a remote control and television screen 18 to order and download a firmware upgrade from a third (3^{rd}) party provider such as the third party storage and distribution system 27. Alternatively, media peripheral and media processing system updates may be subscription based and as a result, may be scheduled to occur automatically or may be done manually.

FIG. 1B is a diagram illustrating an embodiment of a media exchange network 100 supporting local and remote personalized media overlay, in accordance with various aspects of the present invention. Referring to FIG. 1B, the media exchange network 100 may be a communication network comprising a media processing system 104 at a user's home 101, a media processing system 119 located at, for example, an office, friend's or family member's home 102, a third (3^{rd}) party media provider 103, and an Internet-based media exchange network infrastructure 112 which couples the media processing system 104, the media processing 119, and the 3^{rd} party media provider 103.

The Internet-based media exchange network infrastructure 112 may include, for example, cable infrastructure, satellite network infrastructure, xDSL infrastructure, Internet infrastructure, intranet infrastructure and/or other access or transport technology providing wide area network (WAN) connectivity and capabilities.

The media exchange network 100 at the user's home 101 may also comprise media peripheral(s) 106, personal computer(s) 107, and home appliance(s) 108, which may be coupled to the local area network 105. The media processing system (MPS) 104 may include one or more interfaces that may provide connectivity to the local area network 105. The media peripherals 106 may include, for example, a digital camera, a digital camcorder, a MP3 or WMA player, a home and/or portable juke-box system, a PDA, a handheld computer, a PC tablet and a multi-media gateway device, for example. The MPS's 104, 119 may each include a TV screen or monitor 109, 106b, respectively, for viewing a device view or guide, a media view or guide, a channel view or guide, and various sub-menus of each, in accordance with various embodiments of the present invention. The views may be provided by the media exchange server (MES) platforms 110 and 110b, respectively.

Similarly, at the remote location 102, the media exchange network also comprises media peripheral(s) 115, personal computer(s) 116, and home appliance(s) 118 connected together by a local area network (LAN) 117. The local area network 117 also interfaces to the media processing system (MPS) 119.

The local area networks 105 and 117 may be adapted to utilize, for example, wired and/or wireless technology, such as Bluetooth, 802.11a, 802.11b and 802.11g. In this regard, the local area networks 105 and 117 may provide local area network (LAN) capability in accordance with various embodiments of the present invention.

The media processing system 104 may comprise a media exchange software platform 110, a television screen 109, and communication interface(s) 111. The media exchange software platform 110 provides certain functionality within the media processing system 104, such as the ability to access and process media content and alerts from the media exchange network 100. Additionally, the media exchange software platform 110 may provide the ability to display media content and personalized media overlays on the television screen 109. The television screen 109 may be adapted to facilitate selection and display of media content and/or messages. The communication interface(s) 111 allows the media processing system 104 to establish a communication link to the Internet-based media exchange network infrastructure 112.

Personalized media content may originate from one or more of the media peripherals 106, the home appliances 108, the personal computers 107, and/or the remote locations 103, 102. The personalized media content may comprise various types of alerts, for example, the status of media peripherals 106, the status of home appliances 108, an email on a personal computer 107, and a message from another user of the media exchange network at a remote locations 103, 102.

The third (3^{rd}) party media provider 103 may comprise a server 113 and a storage area 114. The storage area 114 may be adapted to store media content provided by the 3^{rd} party provider 103. The server 113 may have the capability to push and/or otherwise communicate media content stored in the storage area 114, as well as personalized media overlay alerts 125 to users of the network for communicating or exchanging media. Similarly, the media processing system 119 may also have the capability to push media content as well as personalized media overlay alerts 125 to users of the media exchange network 100.

FIG. 1C is a diagram illustrating an embodiment of a personalized media overlay window 123 that may be displayed on a television screen 120 of the media processing system 104 in the media exchange network 100 of FIG. 1B, in accordance with various aspects of the present invention. The media processing system 104 may be controlled via a remote control 124. The remote control 124 may communicate with the media processing system 104 via, for example, Bluetooth infrared or RF signals, in accordance with various embodiments of the present invention.

The personalized media overlay window 123 may display to a user of media processing system 104 various types of alert messages from local and/or remote sources. For example, if the media peripheral 106 comprises a digital camera, an alert 125 from the digital camera, indicating that its battery is low, may be passed over the local area network 105 to the media processing system 104. The media processing system 104 may process the alert 125 and generate an alert message which is displayed in the personalized media overlay window 123 to the user of media processing system 104.

In accordance with various embodiments of the present invention, the personalized media overlay window 123 may pop-up on the television screen 120 as soon as the alert message is generated, or a user may use his remote control 124 to bring up the window 123 on the television screen to check for any alert messages. Also, as an alternative, the window 123 may comprise a picture-in-picture (PIP) display instead of a true overlay.

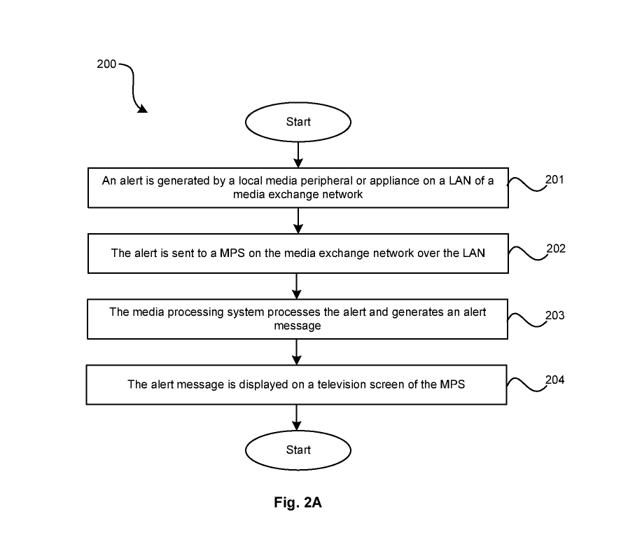

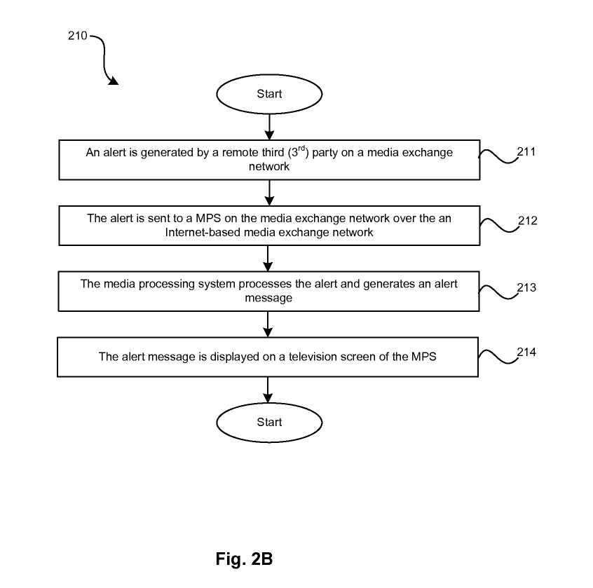

FIG. 2A is a flowchart illustrating exemplary steps for a method that may be utilized to provide a local personalized media overlay in the media exchange network of FIG. 1A, in accordance with various aspects of the present invention. Referring to FIG. 2A, in step 201, an alert is generated by a local media peripheral or appliance on a local area network of a media exchange network. In step 202, the alert is sent to a media processing system on the media exchange network over the local area network. In step 203, the media processing system processes the alert and generates an alert message. In step 204, the alert message is displayed on a television screen of the media processing system in a personalized media overlay window.

In an illustrative embodiment of the invention, a user may be watching a broadcast television program on the television screen 109 of his media processing system 104. While watching the television program, the user's media peripheral 106, for example, a digital camera, may generate a low battery alert 125 and send the alert 125 to the media processing system 104 via the local area network 105. The media processing system 104 may receive the alert 125 and generate a corresponding alert message such as “battery low on digital camera.” Accordingly, the media processing system 104 may automatically cause a personalized media overlay window containing the corresponding generated alert message 123 to pop-up or be otherwise displayed on the television screen 109. The alert message may also be displayed in a picture-in-picture window or as a banner on the television screen 109. As a result, the user may become knowledgeable of the fact that the battery for the digital camera may require recharging prior to its next use.

In accordance with various aspects of the invention, other exemplary embodiments may include an alert from a home appliance 108, for example, a washing machine indicating that a load of laundry has completed a drying cycle, or an alert from a personal computer 107 indicating that a new email message has been delivered to a mailbox. The personalized media overlay window 123 may be adapted to display the header of the email message or the entire email message including header and message body. In another example, caller identification (ID) information from an incoming telephone call may be displayed to a user in the overlay window 123 while the user may be watching a television program. A voice message may also be retrieved from an answering machine message by the media processing system 104 over the local area network 105, converted to a text message by the media processing system 104, and displayed in the overlay window 123. In this case, the media exchange software platform 110 may comprise a speech recognition engine which may provide speech recognition capability within the media processing system 104.

In accordance with another embodiment of the invention, the status of communication devices within the communication network may be provided to a media processing system and displayed on a television screen within a home, for example. In this regard, a status of a media peripheral, home appliance, and/or a person computer may be displayed on a television screen as an alert. Hence, whether a communication device is on or off, in service or out-of-service may be displayed on a television within the home via an alert.

FIG. 2B is a flowchart illustrating exemplary steps for a method that may be utilized to provide a remote personalized media overlay in the media exchange network of FIG. 1B, in accordance with various aspects of the present invention. Referring to FIG. 2B, in step 211, an alert is generated by a remote third (3^{rd}) party media exchange network. In step 212, the alert may be sent to a media processing system on the media exchange network over an Internet-based media exchange network infrastructure. In step 213, the media processing system may process the alert and generate an alert message. In step 214, the alert message is displayed on a television screen of the media processing system.

In an illustrative embodiment of the invention, a user may be watching a video of a child's basketball game on the television screen 109 of the media processing system 104. An alert 125 may be generated by a third (3^{rd}) party media provider 103 indicating that a new documentary film will be available on the media exchange network 100 at the end of the month. The alert 125 may be sent to the media processing system 104 via the Internet-based media exchange network infrastructure 112. The media processing system 104 may process the alert 125 and generate a corresponding alert message, based on the information content of the alert 125. The media processing system 104 may automatically cause the personalized media overlay window 123 to pop-up on the television screen 109 and display the alert message. As a result, the user is made aware of the pending availability of the new documentary film.

In another illustrative embodiment of the invention, the media processing system 104 may be in an idle state, displaying a sequence of art images on the television screen 109 as a type of screen saver. An alert 125 may be generated by a family member at the remote location 102 indicating that they will be stopping by the user's home 101 later in the day. The alert 125 may be sent to the media processing system 104 via the Internet-based media exchange network infrastructure 112. The media processing system 104 may process the alert 125 and generate a corresponding alert message based on the information content of the alert 125. The core of the alert message may have been already generated by the family member and the media processing system 104 may process the message by placing it in a format suitable for display in the personalized media overlay window 123. The media processing system 104 may automatically cause the personalized media overlay window 123 to pop-up on the television screen 109 and display the alert message. As a result, the user may become aware of the pending visit by the family member.

A third (3^{rd}) party provider 103 providing a stock ticker alert indicating when a particular stock owned by the user has gone up or down by at least a certain amount may also be displayed as an alert in accordance with an embodiment of the invention. News bytes of breaking news may also be provided to the user via alerts that may be displayed on a television screen within the home in accordance with an embodiment of the invention. A third (3^{rd}) party provider 103 may also provide a “pinging” service to determine whether the media processing service 104 is properly connected to the media exchange network 100. The “pinging” service may also check that a media peripheral 106, personal computer 107, or home appliance 108 is properly connected to the media exchange network 100 via the local area network 105. If a connection problem is found, an alert message may pop-up in the overlay window 123 to alert the user of a problem. Notwithstanding, ping information may also be reported and displayed on the television screen 109.

In accordance with various embodiments of the invention, a user of the media processing system 104 may utilize the remote control 124 to respond to the alert messages. For example, the user may elect to dismiss or terminate display of the window 123 after reading and/or acknowledging the message. Alternatively, the user could cause the alert message to pop-up again at a later time if the user does not want to interact and/or acknowledge the message at the instant the message is displayed. The user may also have the capability to interact with the alert message using a keyboard, mouse, or remote control. For example, the user may be able to respond to the sender of an email using the remote control 124 and typing a short reply message in the window 123 and sending the reply message over the media exchange network 100.

Although an alert message may automatically pop-up or be otherwise displayed on a personalized media overlay window 123, the invention is not so limited. In this regard, visual effects may also be provided by the media processing system 104 to indicate the existence of an alert from a local and/or remote source. For example, the color on the television screen may toggle between different colors when an alert is received by the media processing system 104. Also, various icons may also be displayed on the television screed to indicate and alert. In accordance with an aspect of the invention, the icons may be graphical images or they may be animated images. The user may then utilize the remote control 124 to view, interact and/or otherwise respond to the alert message that may be in the overlay window 123. Also, a LED on the media processing system 104 may blink or glow with a particular color whenever an alert is received. Audio alerts may also be provided and may be heard from speakers of a television or other media peripheral. The audio alert may include tones, WAV, midi, or other suitable sounds.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

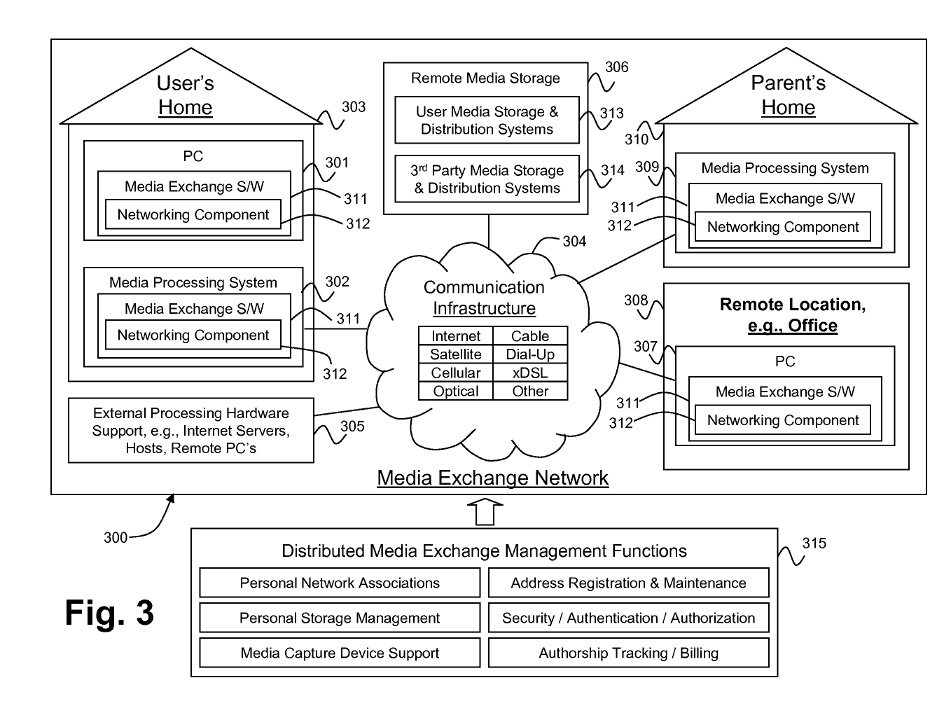

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

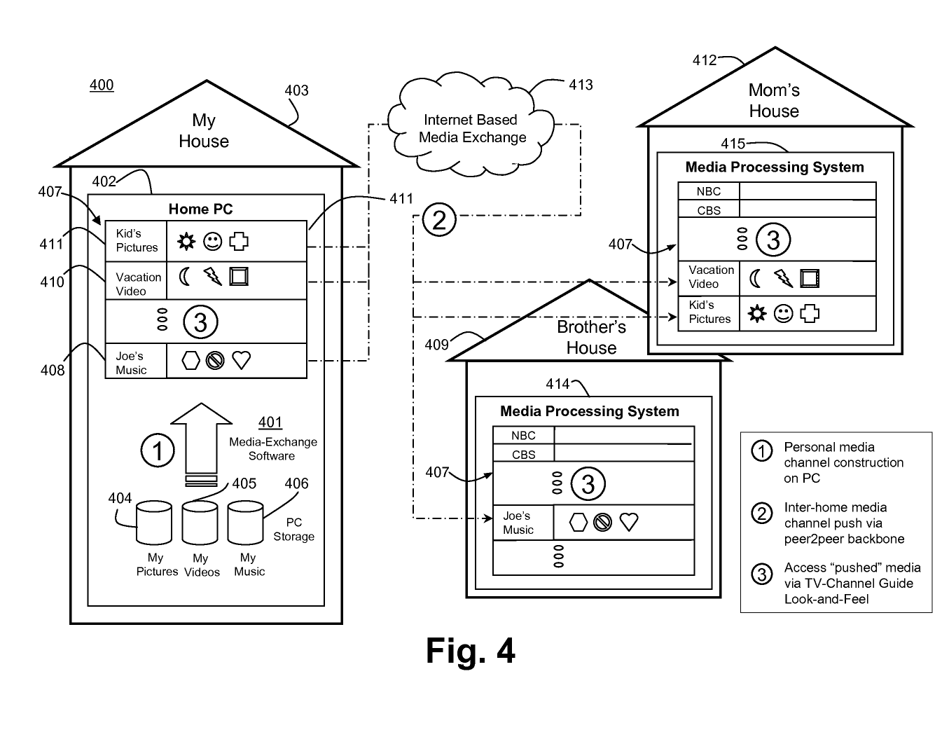

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

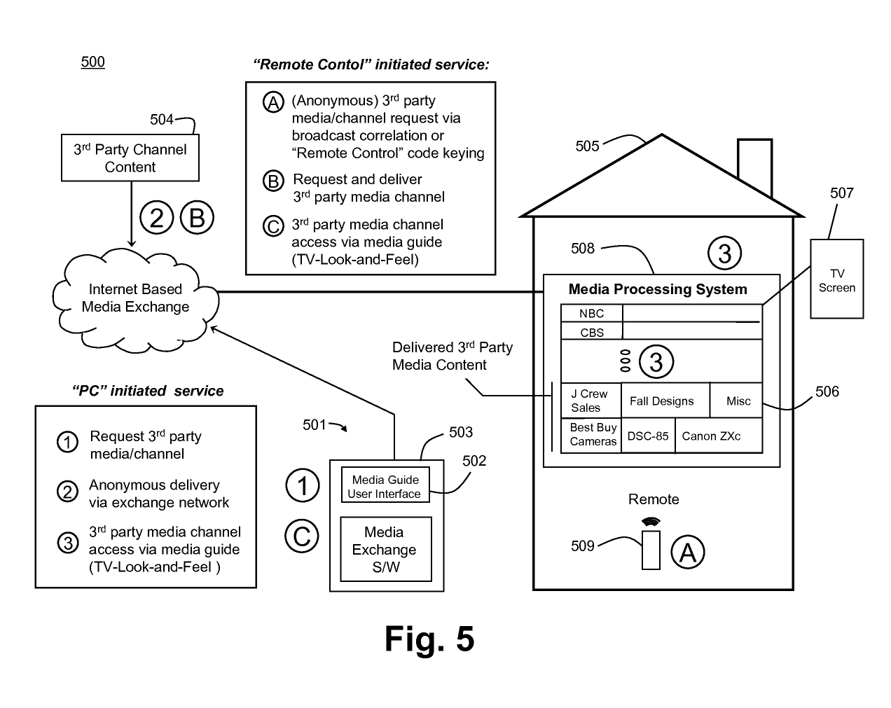

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

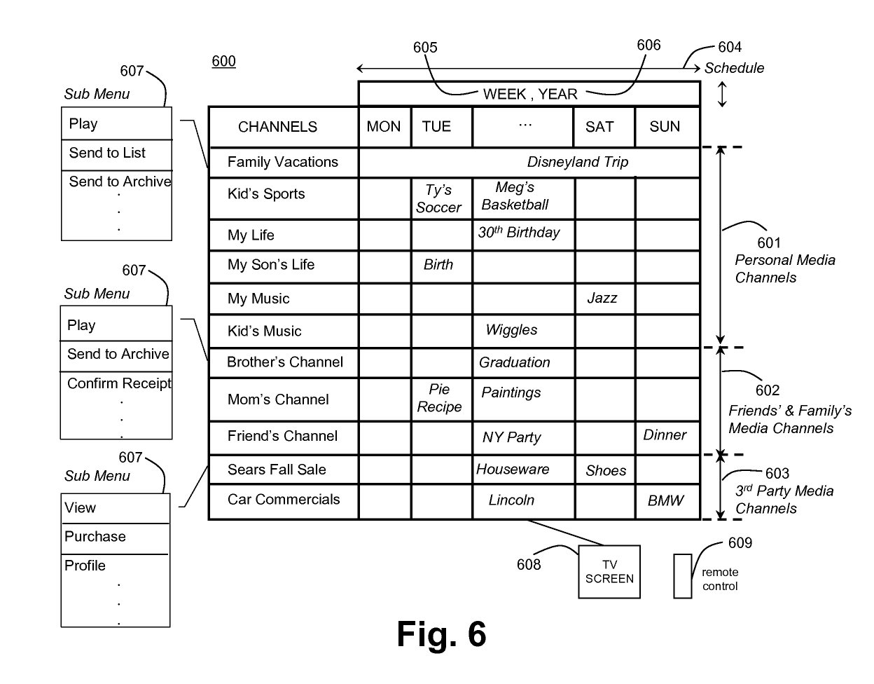

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

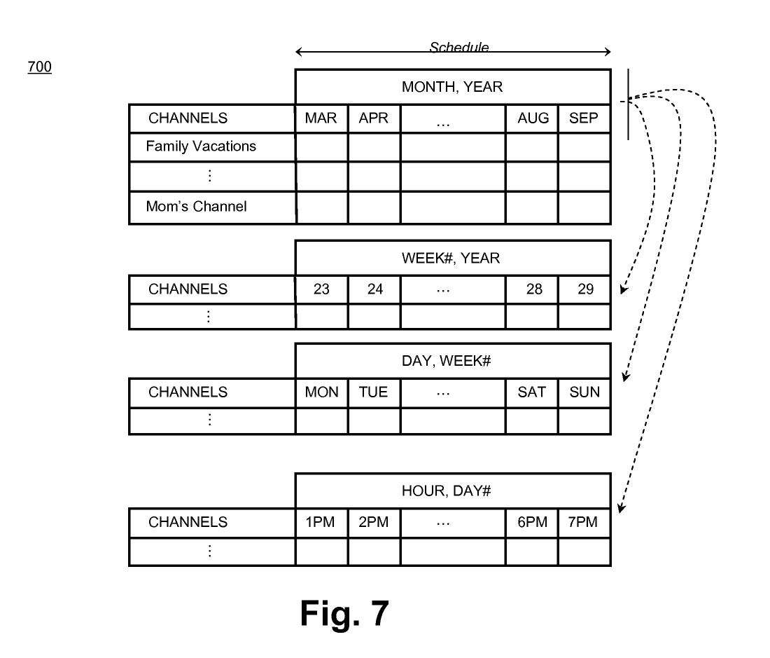

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

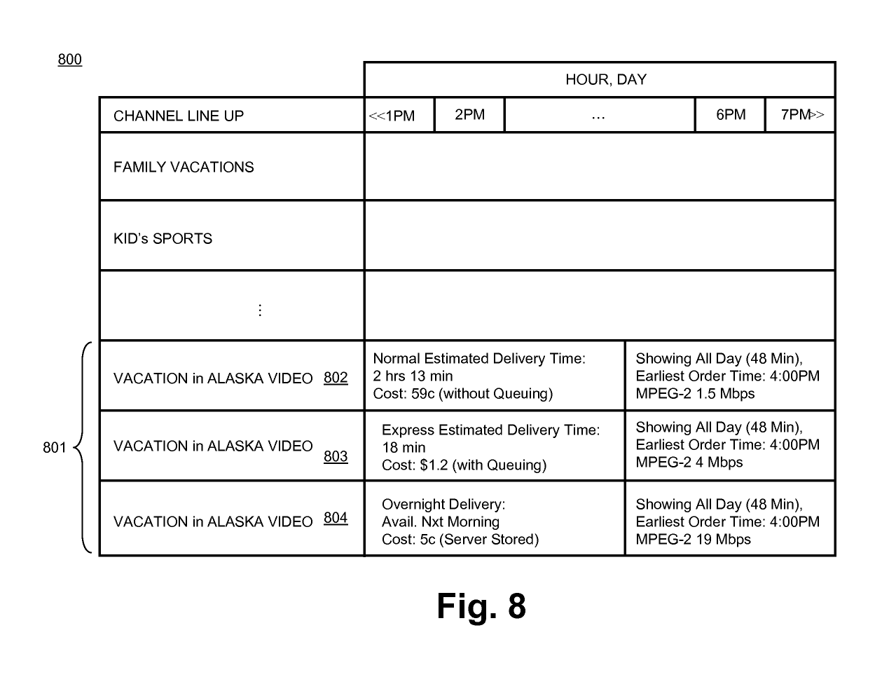

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

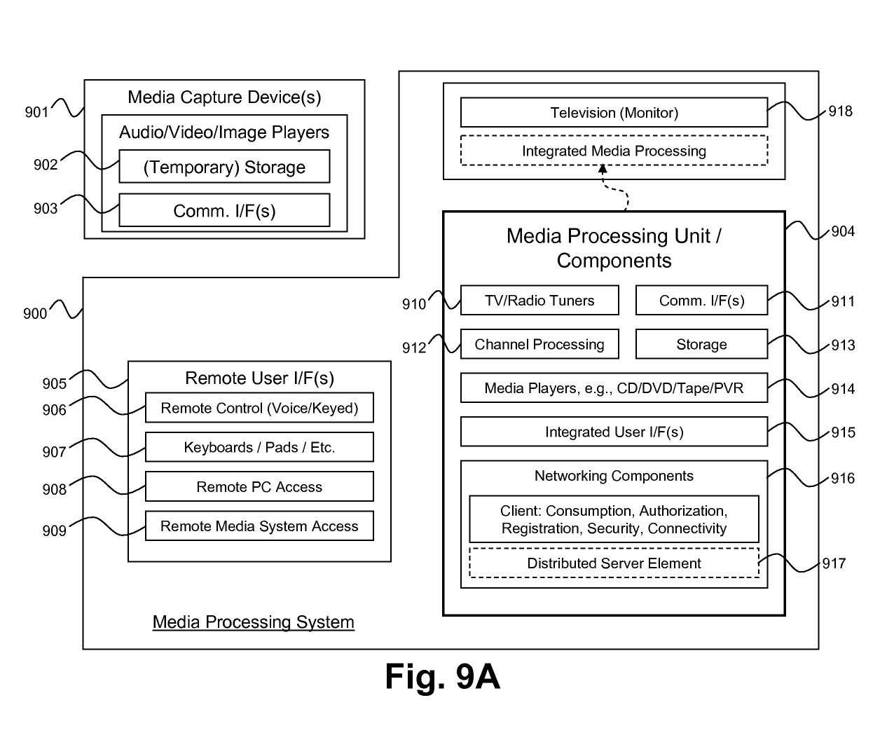

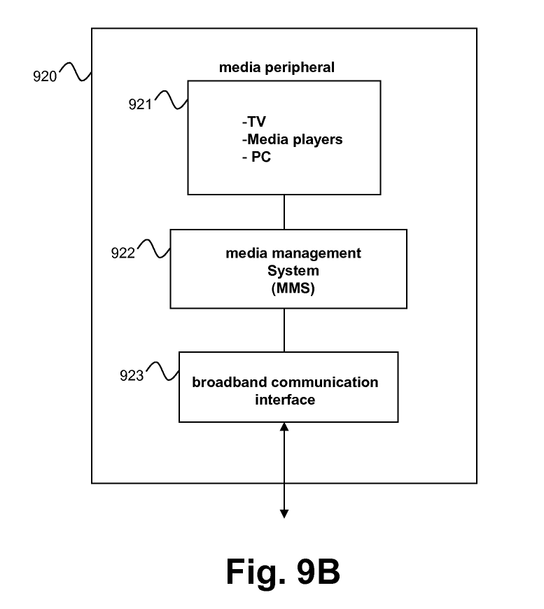

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

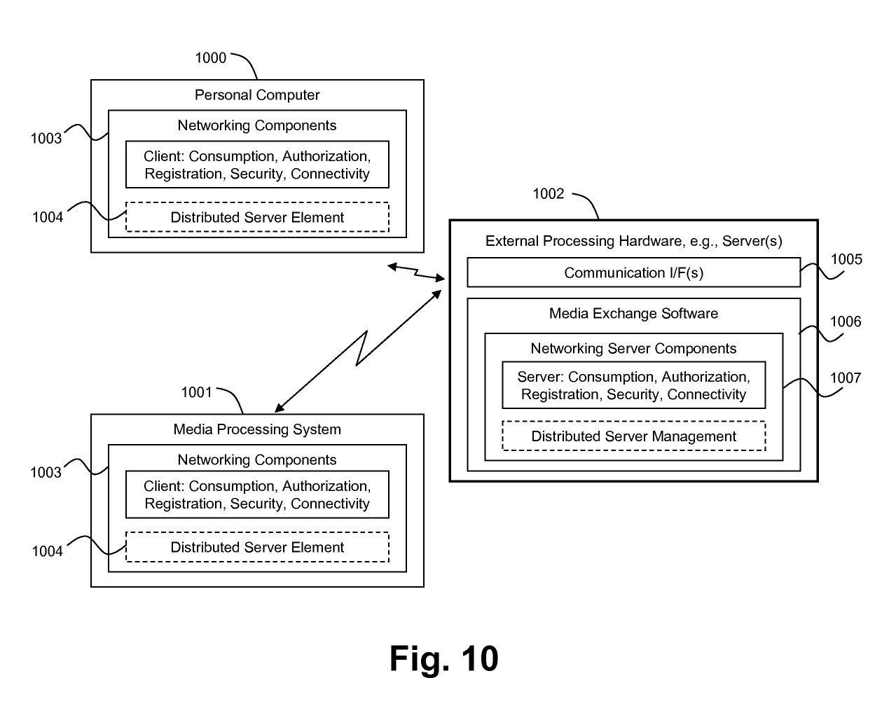

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

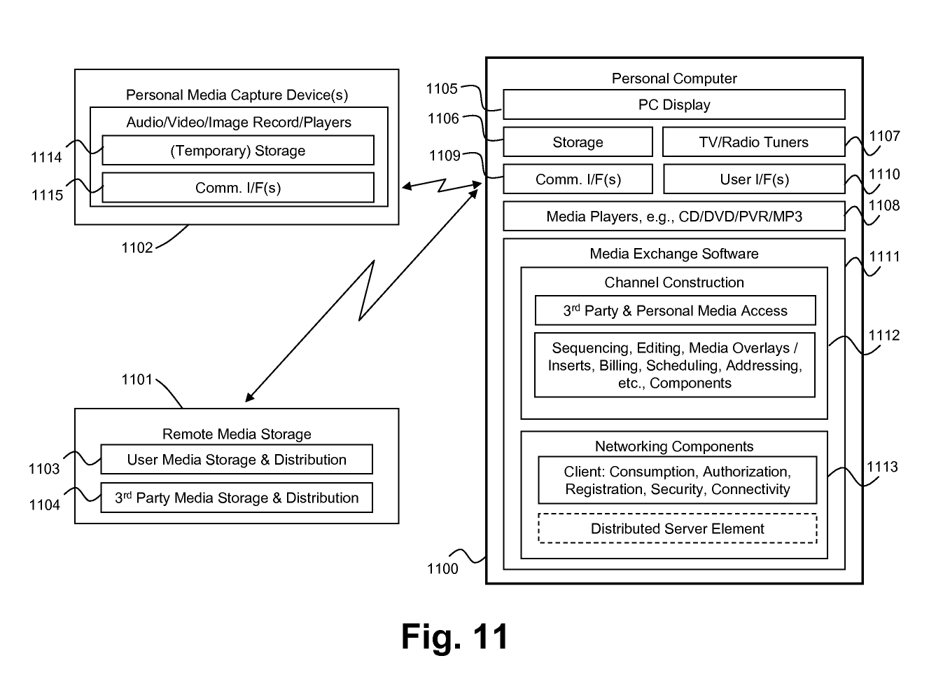

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Another aspect of the invention may provide a system for displaying alerts in a communication network. Certain embodiments of the system may comprise at least one processor that receives an alert from a first device coupled to the communication network. The processor may generate, within a home, a message corresponding to the received alert and may cause the generated message to be displayed on a television screen within the home.

In an aspect of the invention, the processor may cause the generated message to be displayed along with a media broadcast on the television screen within the home. An acknowledgment of the displayed message via a user selection may be received by the processor. The processor may also be adapted to receive an acknowledgement from a remote control that controls various functions of the television screen. The processor may also be configured to terminate displaying of the generated message after receiving the acknowledgement or after the generated message has been displayed for a predetermined or specified period of time.

In accordance with an embodiment of the of the invention, the alert, which may be received by the processor via a wireless and/or a wired connection, may be utilized to indicate a status of the first device and/or a second device. The first device may be located outside the home, while the second device may be located inside or outside the home, for example. The processor may cause the generated message to be displayed in a pop-up window, a picture-in-picture (PIP) window and/or a banner on the television screen. Notwithstanding, the processor may be a media processing system processor, a media management system processor, a computer processor, a media exchange software processor and/or a media peripheral processor.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of indicating an alert from a media peripheral operating within a media exchange network having peer-to-peer media content transfer capability, comprising:
utilizing a media processing system, which has media management capability to exchange media content among a plurality of devices selected to form a media exchange network for exchanging the media content within a closed and secure network environment formed by the media exchange network and in which the media content includes personally captured non-broadcast media content, to receive an alert from a media peripheral that is one of the plurality of devices of the media exchange network;
utilizing the media processing system to communicate the alert to a second device in the media exchange network; and
indicating the alert at the second device.

2. The method of claim 1, wherein the alert is generated to indicate a low battery condition for the media peripheral.

3. The method of claim 2, wherein the media peripheral is an image capturing device.

4. The method of claim 2, wherein the media peripheral is a camera.

5. The method of claim 1, wherein the media exchange network includes a computing device as one of the plurality of devices and wherein the computing device receives emails, further including utilizing the media processing system to receive an email alert from the computing device and communicating the email alert to the second device for indicating the email alert at the second device.

6. The method of claim 1, wherein the media exchange network includes a computing device as one of the plurality of devices and wherein the computing device receives social notifications about a person, further including utilizing the media processing system to receive a social notification alert from the computing device and communicating the social notification alert to the second device for indicating the social notification alert at the second device.

7. The method of claim 1, wherein the media exchange network includes a phone call receiving device as one of the plurality of devices and wherein the phone call receiving device receives phone calls, further including utilizing the media processing system to receive a phone call alert from the phone call receiving device and communicating the phone call alert to the second device for indicating the phone call alert at the second device.

8. The method of claim 1, wherein the media exchange network includes an appliance as one of the plurality of devices, further including utilizing the media processing system to receive an appliance alert from the appliance and communicating the appliance alert to the second device for indicating the appliance alert at the second device.

9. The method of claim 1, wherein when indicating the alert at the second device, the alert is shown on a display for viewing.

10. The method of claim 1, further including testing the media peripheral by the media processing system and generating the alert based on the testing of the media peripheral.

11. An apparatus for indicating an alert from a media peripheral operating within a media exchange network having peer-to-peer media content transfer capability, comprising:
a media processing system, which has media management capability to exchange media content among a plurality of devices selected to form a media exchange network for exchanging the media content within a closed and secure network environment formed by the media exchange network and in which the media content includes personally captured non-broadcast media content, to receive an alert from a media peripheral that is one of the plurality of devices of the media exchange network, the media processing system to communicate the alert to a second device in the media exchange network, and the media processing system to cause an indication of the alert at the second device; and
a communication interface configured to communicate with the plurality of devices of the media exchange network.

12. The apparatus of claim 11, wherein the media processing system is included within a set-top-box, a personal computer or a television.

13. The apparatus of claim 11, wherein the media processing system also performs a test of the media peripheral and the alert is in response to the test.

14. The apparatus of claim 13, wherein the test checks a battery power of the media peripheral and the alert notifies a low battery condition.

15. The apparatus of claim 11, wherein the media processing system also includes a storage to store the media content.

16. The apparatus of claim 11, wherein the media processing system also causes the media content to be distributed to other locations within the media exchange network, in which the media content is represented in a guide simulating a broadcast schedule guide.

17. The apparatus of claim 11, wherein the media processing system causes the alert to be displayed on the second device.

18. A method of indicating an alert from a media peripheral operating within a media exchange network having peer-to-peer media content transfer capability, comprising:
utilizing a media processing system, which has media management capability to exchange media content among a plurality of devices selected to form a media exchange network for exchanging the media content within a closed and secure network environment formed by the media exchange network and in which the media content includes personally captured non-broadcast media content, to receive an alert from a media peripheral that is one of the plurality of devices of the media exchange network;
utilizing the media processing system to cause the media content to be distributed to other locations within the media exchange network, in which the media content is represented in a guide simulating a broadcast schedule guide;
utilizing the media processing system to communicate the alert to a second device in the media exchange network; and
causing the alert to be displayed at the second device.

19. The method of claim 18, wherein when utilizing the media processing system to cause the media content to be distributed to other locations, the media content is distributed in a peer-to-peer transfer.

20. The method of claim 18, wherein the media exchange network includes an appliance as one of the plurality of devices, further including utilizing the media processing system to receive an appliance alert from the appliance and communicating the appliance alert to the second device for causing the appliance alert to be displayed at the second device.
